(19) United States
(12) Patent Application Publication
(10) Pub. No.: US 2010/0243560 A1
(43) Pub. Date: Sep. 30, 2010

(54) Biological Filter for Treating Waste Effluent

(75) Inventors: Philip Herve, Cournonsec (FR); Maunoir Siegfried, Montbazin (FR)

Correspondence Address: BAKER BOTTS L.L.P., One Shell Plaza, 910 Louisiana Street, Houston, TX, 77002-4995, US

(73) Assignee: ERGALIA, Paris (FR)

(21) Appl. No.: 11/562,187

(22) Filed: Nov. 21, 2006

Related U.S. Application Data
(63) Continuation of application No. PCT/FR04/01270, filed on May 21, 2004.

(51) Int. Cl. C02F 11/02

(52) U.S. Cl. 210/605; 210/151; 210/617; 210/618; 210/614; 210/106

(57) ABSTRACT

The invention concerns a filter whereof the reactor comprises: in its bottom part, an inlet for the effluents to be filtered and an outlet of oxygenated gas; in its upper part, an outlet for the filtered effluents; filtering means including media layers and an attached biomass, of density lower than that of the effluents to be filtered and interposed between the inlet and the outlet. The reactor is subdivided by means of racks retaining the filtering means into at least two filtering stages and into an upper outlet stage, wherein emerges the outlet for the filtered effluents. Each filtering stage is provided with a layer and its own filtering means and comprises, in its bottom part, a withdrawing outlet for excess biomass.

The invention relates to a biological filter for treating waste effluent, to a filtration method using such a filter, to a filtration installation comprising a plurality of such filters, and to a treatment plant including at least one such filter or one such filtration installation.

The invention relates more particularly to a biological filter or “biofilter” in which biomass containing suitable microorganisms is fixed to an immersed medium. The effluent for filtration can contain organic and/or inorganic suspended solids that are retained in the filter, and dissolved or particulate organic impurities, which are transformed by the action of the biomass.

Among existing filters, “aerated” filters are already known in which pure oxygen or air is inserted at the same time as the effluent for filtration is inserted, so as to intensify the biological reactions implemented by the biomass. In particular, filters are also known that operate with a rising flow of effluent and in “cocurrent” manner, i.e. both the effluent and the air flow in the same direction, upwards. That arrangement facilitates, in particular, retention of the suspended solids.

In order to sustain the hydraulic and treatment capacities of such filters, it is necessary to perform regular washing in order to remove the surplus biomass that clogs up the medium. That surplus biomass results firstly from the development of the microorganisms (biofilm) and secondly from the retention of the suspended solids and from the transformation of the organic impurities.

In particular, Document FR-A-2 632 947 discloses a filter whose biomass is fixed to a floating medium, the low density of the medium being designed to make said medium easier to wash. In that type of filter, washing is performed by injecting treated water at a high flow rate and in countercurrent manner so as to decompact the materials forming the medium.

Unfortunately, the need for such washing to be performed gives rise to drawbacks. Regular washing cycles consume energy, and make the filtration system complex.

In addition, the entire medium is washed during each cycle, whereas, in view of the heterogeneity of the medium, it would sometimes suffice merely to wash a fraction thereof.

Finally, in certain cases, it is necessary to inject additional water into the filter for washing purposes, which can give rise to over-dilution of the sludge, and can require the sludge to be re-concentrated in a settling tank.

The invention proposes to provide a biological filter that has a rising and cocurrent flow and that is arranged to mitigate those drawbacks.

To this end, in a first aspect, the invention provides a filter for treating waste effluent biologically, said filter being designed to retain the suspended solids and to transform biologically the organic impurities contained in the effluent for filtration, said filter comprising a reactor in which the flow of effluent for filtration is intended to flow upwards from bottom to top, said reactor comprising:
at its bottom, an inlet for receiving effluent for filtration and an inlet for receiving oxygen-containing gas;
at its top, an outlet for removing the filtered effluent; and
filtering means comprising layers of particles of a solid material forming media and biomass fastened to the surfaces of said media, said filtering means having a relative density lower than the relative density of the effluent for filtration and being interposed between the inlet for receiving the effluent for filtration and the outlet for removing the filtered effluent.

In a general definition of the invention, the reactor is subdivided into at least three superposed stage-forming compartments by means of at least two walls provided with openings, said openings being arranged to retain the filtering means, so as to form, in the reactor: at least two filtration stages; and an outlet top stage, the outlet for the filtered effluent leading off from said outlet top stage; each filtration stage being provided with a layer of its own filtering means, and, at its bottom, being provided with a tapping outlet for drawing off any surplus biomass, the quantity and the relative density of the filtering means in each filtration stage being such that, in tapping mode, the bottom portion(s) of at least the lower stage(s) from which the tapping outlet(s) lead off is/are free of any filtering means, so as to enable the surplus biomass to be collected.

The filter of the invention thus has a plurality of filtration stages, it being possible to remove surplus biomass from said filtration stages independently from one another, which makes it possible to implement washing in selective manner by determining, as the filtration method progresses, which fraction of the medium needs to be washed.

The presence of a plurality of filtration stages also offers the advantage of making it possible for the filtration to be modulated by optimally adapting the biomass medium in each filtration stage, thereby making the filtration process more effective.

In a possible embodiment, at least two filtration stages have filtering means that differ, in terms of the types of their media and/or in terms of the type of the biomass fixed thereto, and that differ, for example, in terms of their relative densities.

In a second aspect, the invention provides a method of biologically filtering waste effluent, which method implements a filter as described above, said method comprising a filtering phase comprising the steps consisting in:
feeding the reactor with effluent for filtration and with oxygen-containing gas, in a rising current, respectively via the inlet for the effluent for filtration and via the inlet for oxygen-containing gas;
causing said gas and said effluent to flow upwards through the various successive filtration stages, so as to filter said effluent; and
collecting the filtered effluent via the outlet of the reactor.

The filtration method further comprises a washing phase for washing at least one filtration stage, which washing phase consists in:
closing the effluent-for-filtration inlet and the oxygen-containing gas inlet of the reactor; and
then opening the tapping outlet of the stage to be washed, so as to entrain the surplus biomass by emptying, by means of the pressure difference between the top of the reactor and said tapping outlet.

In a third aspect, the invention provides a filtration installation, comprising a plurality of filters as defined above, said filters being disposed so as to operate in parallel.

The installation is provided with: an effluent-for-filtration inlet connected to the effluent-for-filtration inlet of each of the filters; an oxygen-containing gas inlet connected to the oxygen-containing gas inlet of each of the filters; a filtered-effluent outlet connected to the outlet of each of the filters; and at least one tapping outlet connected to the tapping outlets of each of the filters.

The installation further comprises feed interruption means for selectively interrupting the effluent-for-filtration feed to each of the filters and the oxygen-containing gas feed to each of the filters, filtration control means, shutdown control means, and surplus biomass collection control means, so as to make it possible simultaneously to filter effluent for filtration by using a minimum number of filters, and to shut down the other filters with a view to collecting the surplus biomass and/or to denitrifying at least a portion of the filtered effluent in said other filters.

Finally, in a fourth aspect, the invention provides a waste effluent treatment plant including at least one such filter or one such filtration installation.

Other objects and advantages of the invention appear from the following description given with reference to the accompanying figures, in which:

FIGS. 1 to 4 are diagrammatic views in longitudinal vertical section of a filter of the invention, respectively in first, second, third, and fourth embodiments;

FIGS. 5a and 5b are diagrammatic views in longitudinal vertical section of the filter of FIG. 1, showing implementation of the method of treating waste effluent during the filtration phase (FIG. 5a), and during the washing phase (FIG. 5b);

FIGS. 6a, 6b, 6c, and 6d are diagrams showing the various possibilities of sending the flows of effluent and of gas;

FIG. 7 is a diagrammatic view of a filtration installation of the invention, comprising three filters such as the filter shown in FIG. 1, said filters operating in parallel, and being shown in longitudinal vertical section;

FIG. 8 is a diagrammatic view of a treatment plant of the invention, comprising, in particular, a filter or a filtration installation, a settling tank, and an anaerobic sludge digestion tank, also showing the steps of a method of treating waste effluent in said treatment plant;

FIG. 9 is a diagrammatic view in cross-section of a possible embodiment of a settling tank provided in the treatment plant;

FIG. 10 is a diagrammatic view in section of the settling tank of FIG. 9, on line AA;

FIG. 11 is a view in section of the settling tank of FIG. 9, on line BB of FIG. 10;

FIG. 12 is a diagrammatic view in section, on a longitudinal vertical midplane, of a digestion tank provided in the treatment plant, in a possible embodiment; and

FIG. 13 is a diagrammatic view in perspective of the digestion tank of FIG. 12, seen on the same section.

Reference is made firstly to FIGS. 1 to 3 which show various embodiments of a biological filter 1.

The filter 1 is designed to treat waste effluent biologically. It is designed, in particular, for treating effluent that has firstly been subjected to a settling step serving to remove a large proportion of its suspended solids.

Such a filter performs a plurality of treatment functions in combination:
biologically transforming the organic impurities that are dissolved in the effluent for filtration, under the action of aerobic treatment microorganisms that make it possible firstly to reduce the carbon-containing pollution by transforming organic carbon into inorganic carbon, and secondly to transform organic nitrogen by nitrification and to remove it by denitrification;
retaining the suspended solids, by passing the effluent for filtration through filtering means; and
removing the organic suspended solids.

As described below, such a filter 1 can be included in an installation that comprises a plurality of such filters and, more generally, in a treatment plant further including at least a settling tank and an anaerobic sludge digestion tank.

The filter 1 comprises a closed reactor 2, which, in this example, is substantially cylindrical in shape, and which defines a longitudinal main axis X. The reactor 2 can also be substantially rectangular block shaped. The reactor 2 is disposed so that its main axis X extends substantially vertically.

In the reactor 2, the flow of effluent for filtration is organized to flow in the longitudinally upward direction, with a view to being filtered biologically.

At its bottom, the reactor 2 is provided with an effluent inlet 3 for receiving the effluent for filtration, which inlet is connected to a feed duct 4 provided with a valve 5, and, also at its bottom, said reactor is provided with a gas inlet 6 for receiving oxygen-containing gas, which inlet is connected to a feed duct 7 provided with a valve 8. Feeding in oxygen-containing gas, such as air, is intended to cause the oxygen necessary for the development of aerobic microorganisms used for the filtration to penetrate into the reactor 2.

In a first embodiment, shown in FIG. 1, the two inlets 3, 6 are provided in the bottom wall 9 of the reactor 2 and they make it possible to feed the effluent for filtration and the oxygen-containing gas into an inlet compartment 10. The inlet compartment 10 is defined by the bottom wall 9, by a portion of the side wall 11 of the reactor, and by an internal wall 12 forming the top of the compartment and extending transversely over the entire width of the reactor 2. The internal wall 12 is permeable to the effluent for filtration and to the oxygen-containing gas, so as to allow the effluent and the gas to rise through it.

The purpose of the presence of such an inlet compartment 10 is to enable the flows of effluent for filtration and of oxygen-containing gas to be distributed properly inside the reactor 2, regardless of the inlet flow-rates of the effluent and of the gas. As a result, optimum treatment of the effluent is obtained.

However, it is also possible to make provision for the flows of effluent for filtration and of gas to penetrate into the reactor 2 without going via such an inlet compartment 10. To this end, in a second embodiment that is shown in FIG. 2, the bottom wall 9 of the reactor 2 is provided:
firstly with a plurality of openings 13a that form inlet 3, each of which is connected to a respective duct 13b, said ducts 13b themselves being connected to the feed duct 4 for feeding in effluent for filtration; and
secondly with a plurality of openings 13c that form inlet 6, each of which is connected to a respective duct 13d, said ducts 13d themselves being connected to the duct 7 for feeding in oxygen-containing gas.

The openings 13a, 13c are provided in the bottom wall 9 so as to guarantee that the flows of effluent and of gas are distributed properly. In addition, it is also possible to provide one or more diffusers of fine bubbles of gas, e.g. air, making it possible for the gas to be distributed homogeneously in the flow of effluent for filtration.

The outlet 14 for the filtered effluent is situated at the top of the reactor 2. Said outlet 14 is connected to a removal duct 15 for removing the filtered effluent, which duct is provided with a valve 16, and, in the embodiments shown, said outlet 14 is provided in a side wall 11 and leads off from an outlet top stage 17 of the reactor. The filtered elements are removed by overflowing.

Thus, the filter 1 is of the type having a rising flow, the oxygen-containing gas being fed in in cocurrent manner.

Inside the reactor 2, and interposed between the inlet 3 for the effluent for filtration and the outlet for the filtered effluent, the filter 1 further comprises filtering means 18. The filtering means 18 comprise layers of particles of a microporous solid material forming media, and treatment biomass fastened to the surfaces of said media. For this purpose, the media have been previously seeded with aerobic microorganisms which have developed on said media and have fastened themselves thereto. On implementing the filtration, the fact that the biomass is fastened to a medium makes it possible to optimize the contact between the pollutant matter for treatment and the microorganisms, thereby leading to faster degradation of the organic matter. The filtering means 18 are of relative density lower than the relative density of the effluent for filtration. The relative density of the effluent for filtration depends on the quantity of pollutant matter present, that quantity varying depending on the origin of the effluent and/or on any prior treatment to which said effluent is subjected.

As regards the relative density of the filtering means 18, variants are possible:
in a first variant, the relative density of the filtering means 18 is sufficiently low, relative to the relative density of the effluent for filtration, to ensure that, during the flow of the effluent for filtration, said filtering means always float, regardless of whether gas is present or absent; and
in a second variant, the relative density of the filtering means 18 is higher, and at an intermediate value between the relative density of the mixture of gas and of effluent for filtration and the higher relative density of the effluent for filtration alone; thus while the effluent for filtration is flowing, the filtering means 18 float only in the absence of gas in the reactor 2.

In the embodiments shown in FIGS. 1 to 3, the reactor 2 is subdivided into four compartments that are superposed on one another, in the longitudinal direction of the reactor, thereby imparting a staged structure to the reactor.

The compartments are separated from one another by means of three walls 19a, 19b, 19c, each of which is provided with openings, said walls extending transversely inside the reactor 2 over the entire cross-section thereof. The openings through the walls 19a, 19b, 19c being arranged to retain the filtering means 18 and to allow the flows of effluent for filtration and of gas to pass through. In particular, the openings are distributed over the surfaces of the walls 19a, 19b, 19c in a manner such that they ensure that the effluent and the gas are distributed properly inside the compartments of the reactor 1. For example, the walls 19 provided with openings are gratings of suitable mesh-size.

The compartments thus form inside the reactor 2 firstly three filtration stages, respectively a lower stage 20a, an intermediate stage 20b, and an upper stage 20c, and secondly the outlet top stage 17. The outlet top stage 17 is formed between the top wall 21 of the reactor 2 and the upper wall 19c that is disposed facing said top wall and that is not provided with filtering means.

In the first embodiment, shown in FIG. 1, the lower filtration stage 20a is situated directly above the inlet compartment 10, and it is separated therefrom by the internal wall 12.

In the second embodiment, shown in FIG. 2, the lower filtration stage 20a is defined downwards by the bottom wall 9 of the reactor 2, the openings 13a forming the inlet for the effluent for filtration and the openings 13c forming the inlet for the gas opening out directly into said lower filtration stage 20a.

Each filtration stage 20a, 20b, 20c is provided with its own filtering means 18. While the effluent is flowing upwards through the reactor 2, the filtering means 18 are retained at the tops of the respective filtration stages by the corresponding walls 19a, 19b, 19c. To this end, the geometrical shape and the size of the openings through said walls are adapted to the size and geometrical shape of the filtering means 18.

In its bottom portion, each filtration stage 20a, 20b, 20c is further provided with a tapping outlet 22a, 22b, 22c for drawing off surplus biomass, which outlet is provided in the side wall 11 of the reactor 2. The function of said tapping outlets 22a, 22b, 22c is to enable the surplus biomass that forms in each stage 20a, 20b, 20c during filtration to be removed regularly, such surplus biomass coming not only from the continuous growth of the microorganisms on the media, but also from the accumulation of the suspended solids in each stage.

Each tapping outlet 22a, 22b, 22c is connected to a tapping duct 24 provided with a valve 25. A collection compartment 23a, 23b, 23c for collecting said surplus biomass can be provided, said collection compartment being in communication with the corresponding tapping duct 24.

In each filtration stage 20a, 20b, 20c, the quantity and the relative density of the filtering means 18 are such that, in surplus biomass tapping mode, the bottom portion of each stage from which a tapping outlet 22a, 22b, 22c leads off is free of any filtering means 18.

For this purpose, the quantity and the relative density of the filtering means 18 in each filtration stage 20a, 20b, 20c are organized such that said filtering means 18 float while the surplus biomass is being drawn off, while also being retained in their filtration stage 20a, 20b, 20c by the corresponding wall 19a, 19b, 19c. Thus, during tapping, at the bottom of each of the filtration stages 20a, 20b, 20c, a free space 31 exists that is free of any filtering means.

This arrangement makes it possible for each filtration stage 20a, 20b, 20c to collect the surplus biomass while preventing the filtering means 18 from being entrained simultaneously during the tapping, which might otherwise reduce the filtration capacities of the reactor 2.

In a variant, it is possible, during tapping, for the filtering means 18 of the upper stage 20c to be distributed substantially throughout the volume of said upper stage 20c, rather than being situated at the top only.

In addition, in order to ensure that the filtering means 18 are not extracted from the reactor 2 during the tapping, it is possible to provide retaining means such as walls 19d, 19e, 19f provided with openings, e.g. gratings, disposed in the tapping ducts 24, in the vicinity(ies) of one or more of the tapping outlets 22a, 22b, 22c. The openings in the walls 19d, 19e, 19f or the mesh of the gratings are such that they retain the filtering means 18 in each filtration stage 20a, 20b, 20c, while allowing the surplus biomass to pass through.

In one embodiment, at least one filtration stage 20a, 20b, 20c is provided with detection means 26 for detecting the quantity of surplus biomass. Detection is performed, for example, by emitting a wave beam (an infrared or some other wave beam) and by receiving said wave beam through the environment in question. Such detection means 26 can be as described in Patent Application FR-A-2 731 272. When the filter 1 is operating, the detection means 26 serve to detect the build-up of biomass and to detect when that build-up exceeds the predefined threshold beyond which temporary shutdown of the filter 1 is triggered. The filter is shut down by closing the valves 5 and 8 and by opening the tapping outlet 22a, 22b, or 22c of the stage in question, by opening the corresponding valve 25.

In a possible embodiment, at least two filtration stages 20a, 20b, 20c have filtering means 18 that differ in terms of the types of their media and/or in terms of the types of the biomass fixed thereto.

It is also possible to make provision for the filtering means 18 of at least two filtration stage 20a, 20b, 20c to differ in terms of relative density, so as to adapt the relative densities of the filtering means as well as possible to the quantity of pollutant matter present in each stage, said quantity of pollutant matter influencing the relative density of the effluent for filtration, such adaptation making it possible to ensure that said filtering means float during the tapping. In particular, for at least two of the filtration stages, it is possible to choose filtering means 18 whose relative densities correspond to respective ones of the two above-described variants. For example, it is possible to use media comprising beads of relative density lying in the range 0.5 to 1, and in particular of the order of 0.7.

Each filtration stage 20a, 20b, 20c treats effluent having different properties. The effluent that passes through the successive filtration stages is decreasingly polluted as it flows upwards. And, by means of the staged structure of the reactor 2, it is thus possible to optimize the treatment of the effluent in each of the filtration stages 20a, 20b, 20c, by selecting the filtering means 18 that are best suited to the degree of pollution of the effluent in question, in terms of type of medium, of biomass, or indeed of relative density of the filtering means 18.

The supports used for the filtering means 18 can be formed of beads of diameter lying in the range 1 mm to 30 mm, and in particular in the range 4 mm to 10 mm.

It is possible to use beads of different diameters in the various filtration stages. Said beads can be formed of plastics materials or of expanded inorganic materials, such as expanded glass, expanded clay, or expanded polystyrene. Through their geometrical shape and through the material of which they are made, such media offer the advantage of presenting a large area of exchange with the effluent for filtration.

In addition, the filter 1 can further comprise recirculation means 27 for recirculating the filtered effluent, said means comprising a duct 28 associated with a pump 29, and being provided between the outlet 14 and the inlet 3 for the effluent. The recirculation means 27 are arranged to recover at least a portion of the filtered effluent at the outlet of the reactor 2, and to send said portion back to the inlet 3 of the reactor 2 for additional treatment.

In a third embodiment that is shown in FIG. 3, the recirculation means 27 are arranged to convey at least a portion of the filtered effluent, and therefore of the nitrified effluent, towards a special denitrification stage 30 that is situated at the bottom of the reactor 2. Since the denitrification stage 30 should be an anoxic zone, provision is then made for the oxygen-containing gas inlet 6 to be situated above said denitrification stage 30, and therefore above the inlet 3 for the effluent for filtration, rather at the same level as said inlet 3 for the effluent for filtration.

Reference is made below to FIG. 4, which shows a fourth embodiment of a filter 1 of the invention.

The filter 1 comprises five filtration stages 20. The inlet 3 for the effluent for filtration and the inlet 6 for the oxygen-containing gas are provided in the side wall 11 of the reactor 2, and they open out under the lower filtration stage 20a. The feed duct 4 for feeding in the effluent for filtration extends substantially horizontally from the inlet 3, and then forms a bend and extends substantially vertically along the side wall 11. This arrangement makes it possible, in particular in the event that the filter 1 fails, or in the event that it is necessary to change the feed pump, to prevent the effluent present in the reactor 2 from flowing out by gravity, in undesired manner, through the duct 4.

In addition, at one or more stages, it is possible to provide a duct 32 leading off from the free space 31 from the side wall 11 of the reactor, e.g. substantially opposite from the tapping outlet for drawing off the surplus biomass.

The duct 32 is connected to a monitoring tool, e.g. designed to monitor the pH value of the effluent present in the filtration stage in question.

A window 33 can be provided in the side wall 11 of the reactor 2, at each filtration stage 20. Such a window 33 makes it possible, in particular for the wave beam to be emitted and received by the detection means 26.

By way of example, the characteristics of the filter 1 shown in FIG. 4 can be as follows (filter used in a treatment plant, for treating waste effluent that is predominantly domestic and that has been subjected to prior treatment by primary settlement):
total height of the reactor: 3.33 m;
height of a filtration stage: 0.56 m;
height occupied by the filtering means in a stage: 0.36 m;
type of filtering means: beads of expanded clay;
diameter of the beads: in the range 4 mm to 10 mm;
mass per unit volume of the beads: 0.7 kg/m³;
for a filtration stage area of 1 m² (it being possible, when the filter is cylindrical, for the stage diameter to be in the range 3 m to 4 m, or indeed larger):
   flow rate of effluent for filtration: 140 liters per hour (1/h); and
   flow rate of oxygen-containing gas: 1220 l/h; and
type of oxygen-containing gas used: 80% N₂+20% O₂.

The characteristics of the effluent at the inlet of the plant (as described below) and of said filter, and at the outlet of the filter are as follows:
Chemical Oxygen Demand (COD) at the inlet of the plant: 800 mg/1;
COD at the inlet of the filter: 560 mg/1;
hydraulic head at the inlet of the filter: 0.6 m3/m2.H; and
at the outlet of the filter (without a denitrification step):
   COD≦125 mg/l;
   5-Day Biochemical Oxygen Demand (BOD₅)≦25 mg/l;
   suspended solids≦30 mg/l; and
   Total Kjeldahl Nitrogen (N-NTK)≦10 mg/l

The filter 1 of FIG. 4 can be adapted to accommodate any one of the configurations shown in FIGS. 1 to 3 (the following may or may not be provided: an inlet compartment 10, a plurality of openings 13a, 13c connected to ducts 13b, 13d, a denitrification stage 30, recirculation means 27, etc.).

A method of biologically filtering effluent that uses a filter of the invention is described below with reference to FIGS. 5a & 5b, and 6a to 6d.

Firstly, consideration is given to the filtration phase (FIG. 5a).

Firstly, the valves 5, 8 are opened, thereby causing a flow of effluent for filtration to be sent into the reactor 2, via the inlet 3, and causing a flow of oxygen-containing gas to be sent into said reactor 2 via the inlet 6. The effluent and the gas thus flow upwards, in the direction indicated by the arrows F1 in FIG. 5a.

Various possibilities can be imagined, as regards sending the flows of effluent for filtration and of oxygen-containing gas, as represented diagrammatically in FIGS. 6a to 6d:
in a first variant (FIG. 6a), the effluent for filtration and the oxygen-containing gas are fed in continuously (represented by uninterrupted lines);
in a second variant (FIG. 6b), the effluent is fed in continuously, and the gas is fed in discontinuously (represented in dashed lines);
in a third variant (FIG. 6c), the effluent is fed in discontinuously and the gas is fed in continuously; and
in a fourth variant (FIG. 6d), both the effluent and the gas are fed in discontinuously, simultaneously or otherwise.

When the effluent is fed in discontinuously, it is possible to make provision to adjust the effluent feed so that the reactor 2 receives a certain volume of effluent for filtration only once the preceding volume has been fully received. This makes it possible to obtain an improved distribution of the effluent in the reactor, and also improved treatment.

The effluent inserted into the reactor 2 is filtered successively by flowing upwards through the successive filtration stages 20a, 20b, 20c.

When the effluent reaches the top stage 17, it is removed via the outlet 14 and via the removal duct 15 (arrow F′1).

Optionally, at least a portion of the filtered effluent can be conveyed back into the reactor 2 via the recirculation duct 28 (FIG. F2). Said effluent is thus subjected to additional filtration that makes it possible to improve the degree of treatment. In the filter shown in FIG. 3, the recirculation effluent goes via the denitrification stage 30, where it is subjected to a denitrification step, in an anoxic zone.

In a variant, it is possible to make provision for the inlet 3 for the effluent for filtration and the inlet 6 for the oxygen-containing gas to be closed periodically by acting on the valves 5 and 8, until an anoxic zone is formed that makes it possible for denitrifying microorganisms to develop, by means of which microorganisms the effluent present in the reactor 2 can undergo the denitrification process.

When the oxygen-containing gas comprises air to which gas to be oxidized has been added, the method makes provision to mix external gases with the air sent into the reactor 2, so as to enable said gas to be oxidized. When malodorous gases are produced by other reactors included in the treatment plant in which the filter 1 is situated, oxidation of said gases by passing them through the reactor 2 makes it possible to deodorize them.

Consideration is given below to the washing phase (FIG. 5b), consisting in recovering the surplus biomass that forms as the filtration progresses.

During this phase, the inlet 3 for the effluent for filtration is closed and the inlet 6 for the oxygen-containing gas is closed, by acting on the valves 5 and 8, and the tapping outlet 22a, 22b, 22c of the filtration stage 20a, 20b, 20c to be washed is opened, by opening the corresponding valve 25.

These actions make it possible, by means of the pressure difference between the top of the reactor 2 and the tapping outlet 22a, 22b, 22c in question, to entrain the surplus biomass by drawing off a portion of the effluent contained in the filtration stage 20a, 20b, 20c in question, and of a portion of the effluent situated in the upper stages (as indicated by arrows F3).

The downward flow of effluent makes it possible to clean the filtering means 18, since the surplus biomass comes unfastened from the media to which it was fixed, and, at the same time, entrains the suspended solids retained in the stage 20a, 20b, 20c to be washed. It should be specified that such washing does not affect the treatment potential of the filter 1, since the active biomass remains present in the pores of the media.

During this method, two situations can arise:
either the relative density of the filtering means 18 is sufficiently low for them to float continuously, regardless of whether gas is present in or absent from the reactor 2 (first variant); in which case, the free space 31 that is free of any filtering means is present both during the filtration phase and during the washing phase, at least in the lower filtration stage 20a and in the intermediate filtration stage 20b;
or the relative density of the filtering means 18 is intermediate, and such that they float only in the absence of gas in the reactor 2 (second variant); in which case, the free space 31 that is free of filtering means is formed, at least in the lower filtration stage 20a and in the intermediate filtration stage 20b, only when the gas feed is interrupted. The filtering means 18 being caused to move upwards by the gas feed being shut off contributes to removing the surplus microorganisms from their media, which improves the effectiveness of the washing of the stage in question.

The filtration stage 20a, 20b, 20c to be washed is selected as a function of the quantity of biomass that is contained therein, as detected by the detection means 26.

It is thus possible to wash each filtration stage 20a, 20b, 20c separately when one of them is tending to become clogged (permeability too low), or indeed all of the filtration stage simultaneously if necessary.

During the washing phase, the further away the filtration stage 20a, 20b, 20c is from the top of the reactor 2, the higher the pressure applied to the filtration stage. Thus, the lower stages, in which the filtering means 18 tend to clog up more easily, are washed by a quantity of downwardly flowing effluent that is larger than the quantity washing the upper stages.

In one implementation, the washing phase can be triggered when the detection means 26 detect a quantity of biomass that is greater than the predefined threshold, in at least one of the filtration stages.

Reference is made below to FIG. 7 which shows a filtration installation 34 comprising a plurality of filters 1 disposed so as to operate in parallel.

In embodiment shown, the installation 34 comprises three identical filters 1 of the type of the filter shown in FIG. 1. However, the installation 34 could comprise a higher number or a lower number of filters. The filters could be different from each other, and each of them can correspond to any one of the embodiments shown in FIGS. 1 to 4.

The installation 34 is provided with:
an inlet 35 for effluent for filtration, which inlet is connected upstream to the general feed duct 4 and downstream to three ducts 36, each duct 36 being connected to the inlet 3 for effluent for filtration of a respective filter 1; and
an inlet 37 for oxygen-containing gas, which inlet is connected upstream to the general feed duct 7 and downstream to three ducts 38, each duct 38 being connected to the inlet oxygen-containing gas inlet 6 of a respective filter 1.

Feed interruption means 39 for interrupting the effluent-for-filtration feed are provided between the duct 4 and the ducts 36, so as to enable the effluent feed to some or all of the filters 1 to be closed off. Similarly, feed interruption means 40 for interrupting the oxygen-containing as feed are provided between the duct 7 and the ducts 38, so as to enable the gas feed to some or all of the filters 1 to be interrupted.

Each of the filtered-effluent outlets 14 of the filters 2 is connected to a respective duct 41, the three ducts 41 being connected to the removal duct 15 for removing the filtered effluent. In addition, the tapping outlets 22a, 22b, 22c of each filter 1 are connected to respective ducts 42, the various ducts 42 being connected to a tapping duct 24.

The installation is also provided with control means 43 for causing filtration 43 to take place, with control means 44 for causing the filter to be shut down, and with control means 45 for causing the surplus biomass to be collected.

Thus, by actuating the various means 39 & 40, and 43, 44, & 45, it is possible to filter the effluent for filtration simultaneously via a minimum number of filters, and to shut down the other filters with a view to collecting the surplus biomass, and/or to denitrifying at least a portion of the effluent. It is thus possible, by means of such an installation 34, to manage optimally shutdowns related to collecting the surplus biomass or to implementing the denitrification process.

A treatment plant 46 for treating waste effluent is described below with reference to FIG. 8.

The raw effluent is brought via a feed duct 107 to the inlet of a primary settling tank 100, so as to remove from said effluent a large proportion of its suspended solids.

The primary settling tank 100 is provided with an effluent removal duct 109 connected to the inlet 3 for the effluent for filtration of the filter 1 or to the inlet 35 for the effluent for filtration of the filtration installation 34, via the feed duct 4, and sludge removal means for removing the sludge coming from the settlement.

The sludge coming from the primary settlement is removed to a anaerobic sludge digestion tank 200, so as to enable the sludge to be degraded, the sludge being removed by removal means, such as a removal duct 111, connected to the feed duct 207 for feeding fresh sludge into the digestion tank 200.

The digestion tank 200 is provided with an effluent removal outlet that is connected via a removal duct 209 to the inlet for the effluent for settlement of the primary settling tank 100.

The digestion tank 200 is further provided with a digested-sludge removal outlet connected, via a removal duct 212 to the inlet of a thickener 48.

The thickener 48 is provided with an outlet 49 for residual water that is connected to the effluent feed inlet of the primary settling tank 100 for feeding in effluent for settlement therein, optionally via the removal duct 209 for removing the effluent from the digestion tank 200.

The thickener 48 is also provided with a thickened-sludge outlet 50 for removing thickened sludge. That sludge can be subjected to suitable conditioning and to suitable treatment with a view to being used, in particular, for improving soil. It can also be directed to a landfill site or to an incineration unit.

The effluent that is filtered by the filter 1 or by the filtration installation 34 is removed via a removal duct 15. When the filter 1 is suitable for retaining the suspended solids contained in the effluent for filtration, the filtered effluent is discharged directly. Otherwise, the filtered effluent is directed towards the inlet of a secondary settlement tank 51.

The filter 1 is also provided with tapping outlets making it possible to remove the biomass via tapping ducts 24, which ducts can be connected either to the inlet of the secondary settling tank 51, or when the plant does not have a secondary settling tank, to the effluent-for-settlement feed inlet of the primary settling tank 100 or to the fresh-sludge feed inlet of the digestion tank 200.

The secondary settlement tank 51 is provided with means for removing the sludge coming from the settlement, which means are connected either to the effluent-for-settlement inlet of the primary settling tank 100, via a removal duct 52, optionally opening out into the duct 209, or to the fresh-sludge feed inlet of the digestion tank 200. A portion of said sludge can also be sent back to the head of the filter 1 in order to sustain the biomass at a desired level thereat.

In addition, the secondary settling tank 51 is provided with a removal duct 53 for removing the effluent that has undergone settlement.

In a possible embodiment, shown in FIGS. 9 to 11, the primary settling tank 100 and/or the secondary settling tank 51 each comprise, in a general definition:
a tank 101 having a bottom 103 and, relative to the direction of flow of the effluent, presenting an upstream portion into which a waste-effluent feed duct 107 opens out, and a downstream portion from which the removal duct 109 leads off for removing the effluent that has undergone settlement;
a settling surface disposed in the tank 101, and formed by the top face of at least one settling panel 114, 114′, said panel presenting a mean plane that is substantially parallel to the direction of flow of the effluent and that is inclined, in a plane transverse to the flow of the effluent, and relative to the projection orthogonal to the vertical in said transverse plane, at an angle (α, β).

A first set of at least one settling panel is inclined at a first angle (α) lying in the range 15° to 60°, and at least a second set of at least one settling panel is inclined at a second angle (β) lying in the range 15° to 60°, the angles (α, β), the surface state, and the coefficient of friction of the panels being chosen such that, while the effluent is flowing into the tank, the sludge is deposited on the settling surface and then slides towards the bottom of the tank, at least one removal passageway 117 for removing the sludge being provided between the panels of the two sets, so as to enable the sludge collected on the top faces of the panels to fall by gravity onto the bottom 103 of the tank 101.

The tank 101 is substantially cylindrical, is buried so that the axis 102 is horizontal, and is closed except for four openings:
an effluent-for-settlement inlet opening provided in the upstream end wall 105, the feed duct 107 being extended into the tank via a bend piece 108 that is open upstream;
a removal opening for removing the effluent that has undergone settlement, which removal opening is provided in the downstream end wall 106, a siphon wall 119 provided with an opening 120 being provided for retaining the floating matter inside the tank;
an inspection trapdoor 110 in the top wall 104; and
optionally, a sludge removal orifice for removing the sludge coming from the settlement, which orifice is connected to a removal duct 111, interruption means 112 being provided. In a variant, the removal means can include force pumps that are immersed in the tank 101 or suction pipes extending up to above the tank 101 and connected to a suction pump.

The tank includes two sets of panels that are disposed symmetrically about the longitudinal, vertical midplane 113 of the tank.

The first set (on the left) comprises five substantially parallel panels 114a to 114e that are superposed vertically and that are spaced part from one another at a substantially constant distance L1 of about 30 cm. The panels 114a to 114e are inclined downwards from the substantially vertical side wall of the tank towards the vertical plane 113 at an angle α of about 45°.

The panels 114 present widths 1 that differ depending on how far away they are from the bottom 103 of the tank, whereas they have lengths L (parallel to the flow of the effluent that are substantially equal to one another. The panels 114 are spaced apart from the vertical side wall of the tank 101 by a horizontal distance L2 of about 10 cm, in order to allow suspended solids to pass through, and they are spaced apart from the bottom 103 by a vertical height H of about 30 cm, in order to form a space 115 in which the sludge resulting from the settlement can accumulate. Finally, the top ends of the panels are situated at a distance d below the level 116 of the effluent inside the tank.

The second set (on the right) is symmetrical to the first set about the vertical plan 113, and it comprises five panels 114′a to 114′e. The horizontal spacing L3 between the first and second sets of panels is about 30 cm, so as to form a space 117 enabling the sludge collected on the panels to fall towards the bottom while being directed to and collected in a central zone of the bottom 103 of the tank 101.

Support and fastening means 118 for supporting and fastening the panels 114, 114′ to the tank 101 are disposed in the vicinities of the upstream ends and of the downstream ends of said panels.

In a possible embodiment, and relative to the direction of flow of the effluent, the settling tank 100 includes at least a first and a second series of panels 114, 114′, the second series being situated downstream from the first series, each of said series having at least a first and a second set of at least one panel, so that the extraction of the sludge is further improved.

In a possible embodiment that is shown in FIGS. 12 and 13, and in a general definition, the digestion tank 200 comprises a tank 201 having a bottom 203 that is substantially horizontal, a feed duct 207 for feeding fresh sludge into the tank, a removal duct 209 for removing the effluent from the tank, and removal means 212 for removing the digested sludge from the tank, said tank having at least one wall 213a, 213b, 213c that is transverse to the flow of the effluent, which wall defines an upstream compartment 218a, 218b, 218c, and a downstream compartment 218b, 218c, 218d so that the tank presents a first upstream compartment 218a, into which the fresh-sludge feed duct 207 opens out, and a last downstream compartment 218d from which the effluent removal duct 208 leads off. At its bottom, the wall 213a, 213b, 213c presents a communication opening 216 for putting the upstream compartment into communication with the downstream compartment, so as to allow the sludge to pass and the effluent to flow, above and through the layer of sludge maintained at the bottom of the tank, in a substantially horizontal manner from the first upstream compartment 218a to the last downstream compartment 218d.

The tank 201, which is substantially cylindrical or of substantially rectangular vertical section, and which is positioned so that its axis 202 is horizontal, is closed except for the following openings:
an inlet opening, provided in the upstream wall 205, connected to the fresh-sludge feed duct 207 that forms a bend 208;
an effluent removal opening, provided in the downstream wall 206, and connected to the removal duct 209 that forms a siphon take-off 210;
a digested-sludge removal orifice, in the bottom 203, which orifice is connected to a removal duct 212; and
an inspection trapdoor 211 provided in the top wall 204.

The digestion tank 200 has three transverse walls, respectively an upstream wall 213a, an intermediate wall 213b, and a downstream wall 213c, each of which presents an annular outline 214 that matches the inside shape of the tank 291, and a horizontal top edge 215. The height of the walls is less than the diameter of the tank, and, for example, about 30 cm. A communication opening 216 presenting an annular top edge 217 is provided in the bottom portion of each wall 213a, b, c.

The tank 201 is thus subdivided longitudinally into four compartments 218a, 218b, 218c, and 218d. The walls make it possible to retain in each compartment the sludge formed by build-up of suspended solids, while the surplus floating solids can pass by overflowing from an upstream compartment to a downstream compartment, or indeed vice versa.

The fresh sludge inserted into the digestion tank 200 has a dry matter concentration of less than 25 g/l. Said sludge is deposited on the bottom of the tank, in the form of a thin layer, e.g. a layer of thickness less than 0.5 m. A level 219 of effluent is maintained in the tank 201. The sludge is progressively degraded and liquefied. It then passes through the successive compartments via the communication openings 216. The effluent flows parallel to the axis 202, carrying with it the soluble products resulting from digestion of the sludge.

1. A filter for treating waste effluent biologically, said filter (1) being designed to retain the suspended solids and to transform biologically the organic impurities contained in the effluent for filtration, said filter (1) comprising a reactor (2) in which the flow of effluent for filtration is intended to flow upwards from bottom to top, said reactor (2) comprising:
at its bottom, an inlet (3) for receiving effluent for filtration and an inlet (6) for receiving oxygen-containing gas;
at its top, an outlet (14) for removing the filtered effluent; and
filtering means (18) comprising layers of particles of a solid material forming media and biomass fastened to the surfaces of said media, said filtering means (18) having a relative density lower than the relative density of the effluent for filtration and being interposed between the inlet (3) for receiving the effluent for filtration and the outlet (14) for removing the filtered effluent;
said filter being characterized in that the reactor (2) is subdivided into at least three superposed stage-forming compartments by means of at least two walls (19a, 19b, 19c) provided with openings, said openings being arranged to retain the filtering means (18), so as to form, in the reactor (2):
at least two filtration stages (20a, 20b, 20c); and
at least one outlet top stage (17), the outlet (14) for the filtered effluent leading off from said outlet top stage (17);
each filtration stage (20a, 20b, 20c) being provided with a layer of its own filtering means (18), and, at its bottom, being provided with a tapping outlet (22a, 22b, 22c) for drawing off any surplus biomass, the quantity and the relative density of the filtering means (18) in each filtration stage (20a, 20b, 20c) being such that, in tapping mode, the bottom portion(s) of at least the lower stage(s) (20a, 20b) from which the tapping outlet (s) (22a, 22b) lead off is/are free of any filtering means, so as to enable the surplus biomass to be collected.

2. A filter according to claim 1, characterized in that the outlet top stage (17) is free of any filtering means (18), said stage (17) being formed between the top wall (21) of the reactor (2) and the facing wall (19c).

3. A filter according to claim 1 or claim 2, characterized in that it is further provided with an inlet compartment (10) for receiving the effluent for filtration and the oxygen-containing gas, said compartment (10) being formed between the bottom wall (9) of the reactor (2) and an internal wall (12) that is permeable to the effluent for filtration and to the oxygen-containing gas.

4. A filter according to claim 1 or claim 2, characterized in that the reactor (2) is further provided with a plurality of openings (13a, 13c) which forms respectively an inlet (3) for effluent for filtration and an inlet (6) for oxygen-containing gas, said openings being provided in the bottom wall (9) of the reactor (2).

5. A filter according to any one of claims 1 to 4, characterized in that the walls (19a, 19b, 19c) provided with openings are gratings.

6. A filter according to any one of claims 1 to 5, characterized in that at least one tapping outlet (22a, 22b, 22c) comprises a wall (19d, 19e, 19f) provide with openings and forming retaining means for retaining the filtering means (18).

7. A filter according to any one of claims 1 to 6, characterized in that at least one filtration stage (20a, 20b, 20c) is provided with detection means (26) for detecting the quantity of surplus biomass.

8. A filter according to claim 7, characterized in that the detection means (26) for detecting the quantity of surplus biomass comprises means for emitting and for receiving a wave beam.

9. A filter according to any one of claims 1 to 8, characterized in that at least two filtration stages (20a, 20b, 20c) have filtering means (18) that differ, in terms of the types of their media and/or in terms of the type of the biomass fixed thereto.

10. A filter according to claim 9, characterized in that the filtering means (18) differ in terms of their relative densities.

11. A filter according to any one of claims 1 to 10, characterized in that the media comprise beads whose relative density lies in the range 0.5 to 1.

12. A filter according to any one of claims 1 to 11, characterized in that the media comprise beads of diameter lying in the range 1 mm to 30 mm.

13. A filter according to any one of claims 1 to 12, characterized in that the supports comprise beads formed of plastics materials or of expanded inorganic materials.

14. A filter according to an one of claims 1 to 13, characterized in that it further comprises recirculation means (27) for recirculating the filtered effluent, which means are provided between the outlet (14) and the effluent inlet (3) of the reactor (2), said means (27) being arranged to enable at least a portion of the filtered effluent to be sent back into the reactor (2) for additional treatment.

15. A filter according to claim 14, characterized in that the recirculation means (27) comprise at least one recirculation duct (28) associated with a pump (29).

16. A filter according to claim 14 or 15, characterized in that the reactor (2) further comprises a denitrification bottom stage (30) for denitrifying the effluent coming from the recirculation means (27) and entering the reactor (2), the oxygen-containing gas inlet (6) being situated above said denitrification stage (30).

17. A method of biologically filtering waste effluent, which method implements a filter (1) according to any preceding claim, said method being characterized in that it comprises a filtering phase comprising the steps consisting in:
feeding the reactor (2) with effluent for filtration and with oxygen-containing gas, in a rising current, respectively via the inlet (3) for the effluent for filtration and via the inlet (6) for oxygen-containing gas;
causing said gas and said effluent to flow upwards through the various successive filtration stages (20a, 20b, 20c), so as to filter said effluent; and
collecting the filtered effluent via the outlet (14) of the reactor (2).

18. A method according to claim 17, characterized in that the effluent for filtration and/or the oxygen-containing gas is/are fed in continuously.

19. A method according to claim 17, characterized in that the effluent for filtration and/or the oxygen-containing gas is/are fed in discontinuously.

20. A method according to any one of claims 17 to 19, characterized in that it further comprises a washing phase for washing at least one filtration stage (20a, 20b, 20c), which washing phase consists in:
closing the effluent-for-filtration inlet (3) and the oxygen-containing gas inlet of the reactor (2); and
then opening the tapping outlet (22a, 22b, 22c) of the stage to be washed, so as to entrain the surplus biomass by emptying, by means of the pressure difference between the top of the reactor (2) and said tapping outlet.

21. A method according to claim 20, characterized in that the washing phase is triggered by detecting, in at least one filtration stage (20a, 20b, 20c), a quantity of biomass that is greater than a predefined threshold.

22. A method according to claim 21, characterized in that the quantity of biomass is detected by emitting and receiving a wave beam.

23. A method according to any one of claims 17 to 22, characterized in that the oxygen-containing gas comprises air to which gas to be oxidized has been added.

24. A method according to any one of claims 17 to 23, characterized in that it further comprises a recirculation step for recirculating into the reactor (2) at least a portion of the filtered effluent, so as to perform additional treatment on said portion of the filtered effluent.

25. A method according to claim 24, characterized in that it further comprises a denitrification step for denitrifying said portion of the filtered effluent coming from the recirculation step, by causing said portion of the filtered effluent to flow through a denitrification stage (30).

26. A method according to any one of claims 17 to 25, characterized in that it further comprises a denitrification step for denitrifying at least a portion of the filtered effluent, which step consists in closing the effluent-for-filtration inlet (3) and the oxygen-containing gas inlet (6) of the reactor (2), so as to keep the effluent inside the reactor (2) until an anoxic zone is formed inside said reactor.

27. A filtration installation, characterized in that it comprises a plurality of filters (1) according to any one of claims 1 to 16, said filters being disposed so as to operate in parallel, said installation (34) being provided with:
an effluent-for-filtration inlet (35) connected to the effluent-for-filtration inlet (3) of each of the filters (1);
an oxygen-containing gas inlet (37) connected to the oxygen-containing gas inlet (6) of each of the filters (1);
a filtered-effluent outlet connected to the outlet (14) of each of the filters (1); and
at least one tapping outlet connected to the tapping outlets (22a, 22b, 22c) of each of the filters (1);
said installation further comprising feed interruption means (39) for selectively interrupting the effluent-for-filtration feed to each of the filters (1), feed interruption means (40) for selectively interrupting the oxygen-containing gas feed (34) to each of the filters (1), filtration control means (43), shutdown control means (44), and surplus biomass collection control means (45), so as to make it possible simultaneously to filter effluent for filtration by using a minimum number of filters, and to shut down the other filters with a view to collecting the surplus biomass and/or to denitrifying at least a portion of the filtered effluent in said other filters.

28. A waste effluent treatment plant, characterized in that it includes at least one filter (1) according to any one of claims 1 to 16, or a filtration installation (34) according to claim 27, said plant further including a primary settling tank (100) fed with waste effluent, said primary settling tank (100) having a removal duct (109) for removing the effluent that has been subjected to settlement, which duct is connected to the effluent-for-filtration inlet (3) of the filter (1) or to the effluent-for-filtration inlet (35) of the filtration installation (34), and removal means for removing the sludge coming from the settlement.

29. A treatment plant according to claim 28, characterized in that the primary settling tank (100) comprises:
a tank (101) having a bottom (103) and, relative to the direction of flow of the effluent, presenting an upstream portion into which a waste-effluent feed duct (107) opens out, and a downstream portion from which the removal duct (109) leads off for removing the effluent that has undergone settlement;
a settling surface disposed in the tank (101), and formed by the top face of at least one settling panel (114, 114′), said panel presenting a mean plane that is substantially parallel to the direction of flow of the effluent and that is inclined, in a plane transverse to the flow of the effluent, and relative to the projection orthogonal to the vertical in said transverse plane, at an angle (α, β);
a first set of at least one settling panel (114, 114a, 114b, 114c, 114d, 114e) being inclined at a first angle (α) lying in the range 15° to 60°, and at least a second set of at least one settling panel (114′, 114′a, 114′b, 114′c, 114′d, 114′e) being inclined at a second angle (β) lying in the range 15° to 60°, the angles (α, β), the surface state, and the coefficient of friction of the panels being chosen such that, while the effluent is flowing into the tank, the sludge is deposited on the settling surface and then slides towards the bottom of the tank, at least one removal passageway (117) for removing the sludge being provided between the panels of the two sets, so as to enable the sludge collected on the top faces of the panels to fall by gravity onto the bottom (103) of the tank (101).

30. A treatment plant according to claim 28 or 29, characterized in that it further comprises a secondary settling tank (51) provided with:
an inlet for effluent for filtration, which inlet is connected to the tapping outlets (22a, 22b, 22C) of the filter (1);
an outlet for the effluent that has undergone settlement; and
removal means for removing the sludge coming from the settlement.

31. A treatment plant according to any one of claims 28 to 30, characterized in that it further comprises an anaerobic sludge digestion tank (200) provided with:
a fresh-sludge feed inlet connected to the removal means for removing the sludge coming from the settlement of the primary settling tank (100);
an effluent removal outlet connected to the effluent-for settlement feed inlet of the primary settlement tank (100); and
a digested-sludge removal outlet.

32. A treatment plant according to claim 31, characterized in that the digestion tank (200) comprises a tank (201) having a bottom (203) that is substantially horizontal, a feed duct (207) for feeding fresh sludge into the tank, a removal duct (209) for removing the effluent from the tank, and removal means (212) for removing the digested sludge from the tank, said tank having at least one wall (213a, 213b, 213c) that is transverse to the flow of the effluent, which wall defines an upstream compartment (218a, 218b, 218c), and a downstream compartment (218b, 218c, 218d) so that the tank presents a first upstream compartment (218a), into which the fresh-sludge feed duct (207) opens out, and a last downstream compartment (218d) from which the effluent removal duct (208) leads off, said treatment plant being characterized in that, at the bottom of the wall (213a, 213b, 213c), said wall presents a communication opening (216) for putting the upstream compartment into communication with the downstream compartment, so as to allow the sludge to pass and the effluent to flow, above and through the layer of sludge maintained at the bottom of the tank, in a substantially horizontal manner from the first upstream compartment (218a) to the last downstream compartment (218d).

33. A treatment plant according to claim 31 or claim 32, characterized in that it further comprises a thickener (48) having:
an inlet connected to the digested-sludge removal outlet of the digestion tank (200);
an thickened-sludge outlet; and
a residual-water outlet connected to the effluent-for-settlement feed inlet of the primary settlement tank (100).
